(19) United States
(12) Patent Application Publication
(10) Pub. No.: US 2025/0207652 A1
(43) Pub. Date: Jun. 26, 2025

(54) DAMPER WITH TIERED RESPONSE

(71) Applicant: TITUS D.O.O. DEKANI, Dekani (SI)

(72) Inventors: David PECAR, Pobegi (SI); Nejc STRAVNIK, Piran (SI)

(21) Appl. No.: 18/848,100

(22) PCT Filed: Mar. 17, 2023
(86) PCT No.: PCT/EP2023/056965

§ 371 Date: Sep. 17, 2024

(30) Foreign Application Priority Data
Mar. 25, 2022 (GB) 2204286.5

(51) Int. Cl. F16F 9/504; F16F 9/36

(52) U.S. Cl. CPC F16F 9/504; F16F 9/368; F16F 2222/12; F16F 2230/30

(57) ABSTRACT

A piston-and-cylinder-type damper operable to perform a compression stroke and a return stroke, comprising a casing containing damping fluid, an O-ring inside the casing, and a piston assembly having a contact surface facing the O-ring is provided. When a compression speed or force of the piston assembly is relatively low, the O-ring is disposed at a first position relative to the piston assembly defining a first pathway and a second pathway for the damping fluid to flow from a first chamber to a second chamber, and when the compression speed or force of the piston assembly is relatively high, the O-ring is disposed at a second position relative to the piston assembly blocking the first pathway and allowing the damping fluid to flow only through the second pathway, wherein the first passageway is defined between an outer perimeter of the piston assembly and an inner wall of the casing.

### TECHNICAL FIELD

The present invention relates to a piston and cylinder type damper.

### BACKGROUND

In many practical situations it is necessary to provide a damper, in which a piston in combination with a valve can produce a variable damping force, namely a smaller force at lower closing velocities of the compression stroke, and a greater force at higher speeds. A lower damping force means a lower force is needed to close the self-closing mechanism of a sliding door, drawer, or cabinet door, for example, in which the damper is installed. It is also related to a lower spring opening force. However, when the closing force or speed is high, an increased damping response is desirable, for instance to prevent damage to the mechanism and/or to the piece of furniture.

EP 2472140 B1, EP 3480400 A1, EP 3714184 A1 and WO 2021/115515 A1 provide dampers in which the damping response is defined by damping fluid flowing through gap(s) between the outside perimeter of a piston assembly and the housing of the damper, and a passage formed in the piston internally. When there is a high closing force, a disk deforms under pressure and causes the closing of the internal passage. This is disadvantageous as the final force definition, when the closing force is high, is dependent on the manufacturing tolerances of both the piston assembly and the housing. Furthermore, with time, wear and tear would also affect the malleability and deformability of the disc as well as both the housing and the piston, causing the mechanism to lose precision in response definition. This means that the damping force could vary through the working life of the damper, leading to unpredictability and unreliability before eventual failure.

Accordingly, there is a need in the field for a new damper arrangement that avoids or reduces such problems.

### SUMMARY OF THE INVENTION

A piston and cylinder type damper is herein disclosed. When a high damping force is required in response to a strong closing impulse, the damping response profile is defined solely by the form of the piston assembly, and not dependent on the housing. The design and any possible deterioration of the housing is therefore taken out of the equation, when designing and manufacturing the damper for a high damping response, as the piston assembly can be more easily designed, manufactured and controlled with greater accuracy. It is also possible to model its behaviour through its life cycle with greater confidence.

In accordance with an aspect of the present invention, there is disclosed a piston-and-cylinder-type damper operable to perform a compression stroke and a return stroke, comprising a casing/cylinder containing damping fluid, an O-ring inside the casing, and a piston assembly having a contact surface facing the O-ring, wherein, during a compression stroke, when a compression speed of the piston assembly or a force applied thereon is relatively low (below a certain threshold), the O-ring is disposed at a first position relative to the piston assembly defining a first pathway and a second pathway for the damping fluid to flow from a first chamber to a second chamber, and when the compression speed or force of the piston assembly is relatively high (above the threshold), the O-ring is disposed at a second position relative to the piston assembly blocking or sealing the first pathway and allowing the damping fluid to flow only through the second pathway, wherein the first passageway is defined around the perimeter of the piston assembly, i.e. between said outer perimeter and an inner wall/surface of the casing.

Preferably, the O-ring is made of a flexible material, and is deformed when at the second position and not deformed when at the first position.

Preferably, when in the first position the O-ring is tilted at an angle with respect to the contact surface, the angle defined as between the plane of the O-ring and the plane of the contact surface. Preferably, the angle is non-zero when the O-ring is in the first position, most preferably between 2 and 8 degrees. Preferably, the plane of the O-ring and the plane of the contact surface are parallel when the O-ring is in the second position.

Preferably, the second pathway for the damping fluid to flow from the first chamber to the second chamber is an internal passage in the piston assembly, defined away from the perimeter of the piston assembly, but off-centre. Preferably, the second pathway has an opening on the contact surface at a position corresponding to the central hole of the O-ring (i.e. it opens into said O-ring hole).

Preferably, the contact surface of the piston assembly comprises a protrusion, and when the compression speed or force of the piston assembly is relatively high above the threshold, the O-ring is forced against the contact surface and deformed to wrap around the protrusion whilst in the second position. Preferably, the contact surface of the piston assembly comprises exactly one protrusion.

In one aspect, the O-ring comprises a protrusion facing the contact surface, and, when the compression speed or force of the piston assembly is relatively high, the O-ring is forced against the contact surface whilst in the second position.

In one aspect, the contact surface further comprises at least one groove, and/or the O-ring comprises at least one groove facing the contact surface.

Preferably, the outer circumference of the O-ring is dimensioned such that at all times it is snug against the inner wall of the casing so that, during a compression stroke or a return stroke, the damping fluid can only flow past the O-ring through its central hole. Preferably, the O-ring has a diameter that is at least as large as the inner diameter of the casing.

In one aspect, the threshold of the compression speed or force on the piston assembly, above which the O-ring blocks the first pathway and below which it does not, is defined by the stiffness of the O-ring, as well as the shape or size of the O-ring and/or the protrusion.

In accordance with an aspect of the invention, there is disclosed a piston-and-cylinder-type damper operable to perform a compression stroke and a return stroke, the damper comprising a cylinder containing damping fluid and having an inner wall, a flexible O-ring, and a piston assembly having a contact surface comprising a rib facing the O-ring, wherein the O-ring is operable to move, dependent on a speed of a compression stroke, between: a first angle, at which the O-ring flexes around the rib and seals off a first damper fluid passage between a perimeter of the piston assembly and the inner wall of the cylinder (for flow from a first chamber to a second chamber of the damper), and a second angle, at which the O-ring leaves open the first damper fluid passage, said first and second angles defined as between a plane of the O-ring and a plane of the contact surface.

Preferably, the first angle is zero and the second angle is between 2 and 8 degrees.

Preferably, there is provided a second damper fluid passage defined solely in the piston assembly, internally i.e. away from the perimeter of the piston assembly, wherein the second damper fluid passage is open to the damping fluid when the O-ring is at the first angle and when the O-ring is at the second angle, i.e. regardless of the inclination of the O-ring relative to the piston assembly.

In order that the present invention be more readily understood, various aspects of specific embodiments will now be described in conjunction with the attached drawings.

### BRIEF DESCRIPTION OF THE DRAWINGS

FIG. 1 shows a damper device in accordance with an embodiment of the present invention.

FIG. 2 shows a close-up view of part of FIG. 1.

FIG. 3A shows a close-up view of the damper with the O-ring in a first configuration when the first fluid pathway is accessible.

FIG. 3B shows a close-up view of the damper with the O-ring in a second configuration when the first fluid pathway is inaccessible.

FIGS. 4A, 4B and 4C show part of the piston assembly in different embodiments.

FIGS. 5A and 5B show the O-ring in different embodiments.

### SPECIFIC EMBODIMENTS

Various aspects of the invention are described below.

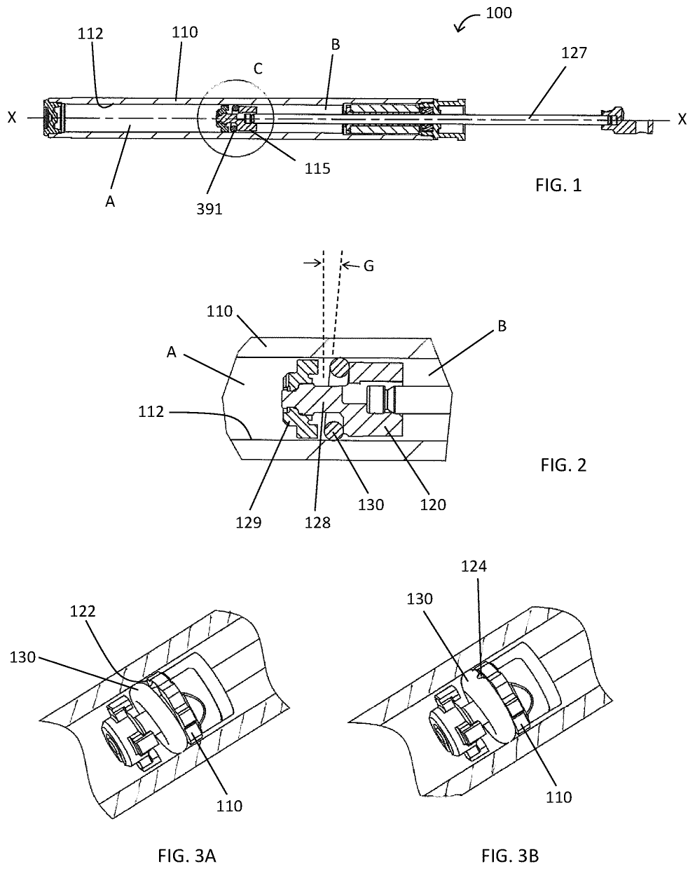

FIG. 1 shows a piston-and-cylinder-type damper or damper assembly 100. A close-up of the circled region C is shown in cross-section in FIG. 2, and in three dimensions in FIGS. 3A and 3B in two different configurations. The damper comprises a housing or casing 110, which is typically cylindrical in shape, with an inner (cylindrical) wall/surface 112. There is also a piston assembly 120 comprising a piston rod 127 mounted for linear reciprocal movement with respect to the casing 110 along a longitudinal axis X. Other standard features of a piston-and-cylinder-type damper device are not described here.

The piston assembly 120 divides the interior of the cylinder 110 into two separate chambers, chamber A (compression chamber) and chamber B (reserve/overflow chamber), on the left and right side, respectively, in FIG. 1. There is provided a sealing means 130 that works as a seal for the housing 110 and is configured to moveably engage the end section of the piston assembly 120 closest to chamber A. Specifically, it is configured to moveably interact with the piston assembly 120 at a contact surface 122 thereof. This sealing means 130 is preferably an O-ring.

Preferably, this end section of the piston assembly 120 comprises the contact surface 122 which faces the chamber A, a stem 128 extending from said contact surface 122 and culminating in an end cap 129. The O-ring 130, with the stem 128 extending through its central hole, has a limited level of freedom in its longitudinal movement and its angle of tilt with respect to axis X, by moving in the space between the contact surface 122 and the end cap 129.

On a compression stroke of the damper 100, whereby the piston assembly 120 is pushed in the inward direction (leftward in FIG. 1), damping liquid flows from chamber A to chamber B through one or more pathways or passageways defined by the components of the damper, such as one or more of the piston assembly 120, housing 110 and the O-ring 130. On the return stroke of the damper, the piston 120 is moved in the opposite, outward direction (rightward in FIG. 1), and the damping fluid flows from chamber B to chamber A. Note that in the present embodiment it is not envisaged that the return stroke of the damper be aided by a return means such as a spring located on the side of chamber A, although it is possible to include such means.

The aforementioned one or more pathways are defined so as to result in a controlled flow of damping fluid when the damper is being actuated; it is especially crucial that the compression stroke leads to a predictable damping response or damping profile when the closing speed is high. These pathways will be explained in detail below.

The damping response is variable or tiered, dependent on the compression force to which the damper 100/piston assembly 120 is subjected. When that compression force/pressure is low (e.g. below a certain force threshold), the damping response is relatively small, or zero; when it is high (e.g. at or above the threshold), the resulting damping force is high, relative to the low-compression mode. This may be implemented by reducing the number or total cross-sectional area of the pathways for the damping fluid to go from chamber A to chamber B in the second scenario compared to the first scenario. By controlling the degree of restriction presented by the pathways, the flow of fluid past the piston assembly 120 can be precisely tailored to give the desired amount of damped resistance.

As mentioned, it is important that in the fast-compression, high-damping mode, the damping force response is not linked to the design or condition of the housing 110; in other words, the fluid must not flow through any pathway that is between the internal housing wall 112 and the perimeter 123 of the piston assembly 120. This further improves the precision of the expected damping profile. Any such pathway available in the low-damping mode is sealed off in the high-damping mode. This is enabled by the following arrangement of piston assembly 120, O-ring 130 and housing 110.

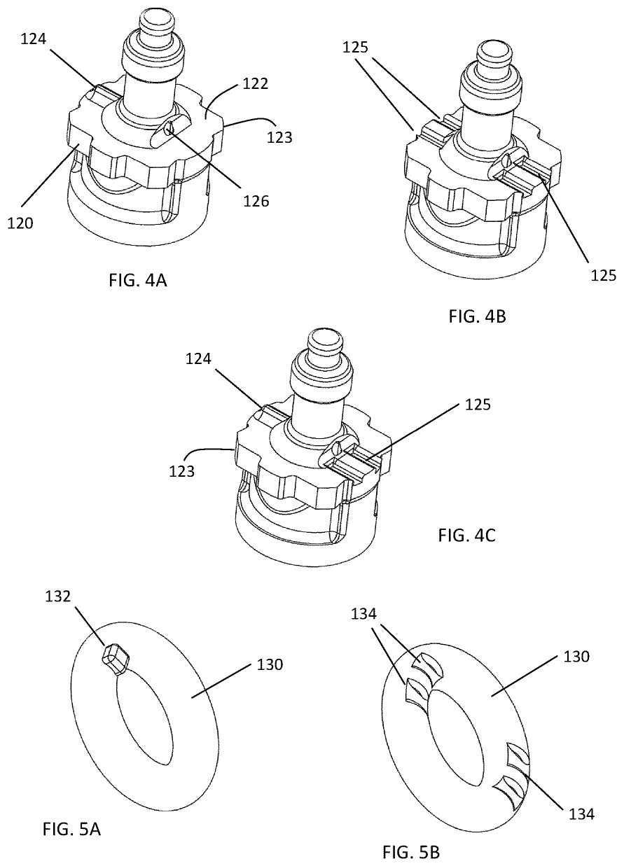

At the contact surface 122 of the piston assembly 120, its cross-sectional shape is smaller in size than the inner circumferential wall 112 of the housing 110. Preferably, it is only slightly smaller in size (although at its maximum the diameter may be same or substantially same as that of the housing). Preferably, this shape is not cylindrical. For example, the exact design may comprise indentations/cut-outs/grooves as most clearly seen in FIGS. 4A to 4C, which, when the piston is in place, one or more channels are defined between the housing 110 and (the perimeter 123 of) the piston assembly 120 for the fluid to flow between chambers A and B (also see FIGS. 2, 3A and 3B). This forms part of a first pathway for the damping fluid.

In the main body of piston assembly 120 itself, there is defined a channel or through-hole 126, which is preferably an internal passage in the piston assembly 120 away from the perimeter 123, as seen clearly in FIGS. 4A to 4C. This connects chamber A and chamber B like a tunnel, having a first opening on the contact surface 122 on the side of chamber A and a second opening on the other side (chamber B) serving as entrance and exit, respectively, for damping fluid on a compression stroke. This forms part of a second pathway for the damping fluid. Alternatively, instead of just one such through-hole 126, a plurality of internal channels could be defined in the piston assembly to serve as part of the second pathway between A and B.

The O-ring is configured to move between a first and a second configuration/position relative to the piston assembly, as illustrated in FIGS. 3A and 3B, respectively. On a compression stroke, the piston assembly 120 moves along its longitudinal axis X towards chamber A. This leads to the contact surface 122 being pushed towards the O-ring 130. It is provided that, when the compression stroke is strong (at high speed), the O-ring 130 is in the second configuration (relative to the piston contact surface 122) that blocks the first pathway, thus only allowing fluid to flow via the second pathway. When the compression is stroke is weaker, below a certain threshold (at lower speed), the O-ring 130 is in the first configuration (relative to the piston contact surface 122) that fails to block the first pathway, and therefore fluid can now pass from chamber A to B using both the first and second pathways. This relative change in configuration/position of the O-ring 130 implements the two-tiered damping response on the compression stroke of the damper 100.

In one aspect of the invention, when in the second configuration, the O-ring 130 is in full or close contact with the contact surface 122 of the piston assembly 120, to the extent that the fluid that manages to flow past the hole of the O-ring 130 is not able to access the first pathway, i.e. the outer conduits defined between the perimeter 123 of the piston 120 and the housing 110. This is illustrated in FIG. 3B. Preferably, the plane of the O-ring 130 is parallel to the plane of the contact surface 122, perpendicular to axis X.

In the first position of the O-ring 130, the fluid is able to access the first pathway after flowing past the hole of the O-ring. This is illustrated in FIG. 3A, and in cross-section in FIG. 2.

In one aspect of the invention, the first and second configurations differ in an angle of inclination of the O-ring 130. In this case, there is provided, on the contact surface 122 of the piston assembly 120, means for tilting the O-ring 124. This means may comprise a protrusion 124 or a rib extending from the contact surface 122 towards the direction of the O-ring 130, as shown in FIG. 4A. In the absence of a sufficiently strong pressure on the compression stroke, the O-ring 130 is merely lightly pushed along in the inward direction by the contact surface 122 including its protrusion 124; this obstruction by the protrusion 124 means that the O-ring 130 is prevented from being in complete contact with the contact surface 122.

However, in the fast-compression mode, a strong external force on the piston 120 drives the contact surface 122 towards the O-ring 130 at such a speed or strength that the O-ring deforms or flexes to wrap around the protrusion 124. Hence the O-ring 130 is both a sealing part and a deformable part of the damper apparatus 100. The O-ring is made of a sufficiently flexible or pliant material such as rubber or other suitable plastic/polymer materials, so that this elastic deformation is possible, and reversible. The O-ring is preferably of standard design, with a simple toroid shape (not illustrated). In its deformed state, the O-ring is in full contact with the contact surface 122 of the piston 120 (as seen in FIG. 3B).

The means for tilting the O-ring may comprise a plurality of protrusions, though preferably there is a single protrusion 124 positioned to one side (i.e. it is not centrally disposed on the contact surface 122), as shown in FIG. 4A; this provides a simple way to ensure that the shape of the contact surface is asymmetrical and the O-ring is inclined at an angle.

In the low damping mode when the compression force is below a predetermined threshold, the O-ring 130 is either not in contact at all with the front-facing end 122 of the piston assembly 120, or otherwise it touches said contact surface but is not in tight contact and thus unable to seal off the outer circumference 123 of the piston 122 in the casing 100. This leaves a three-dimensional wedge-shaped gap between the contact surface of the piston assembly and the closer side of the O-ring, as can be seen in FIGS. 2 and 3A. In this way, damping fluid in chamber A can go through the central hole of the O-ring 130 into this gap and access the channels between the outer side 123 of the flange of the piston assembly 120 and the interior surface 112 of the housing 110, to reach chamber B (i.e. the first pathway). It also enters the through-hole 126, which is never sealed off as it opens into “empty space” where the hole of the O-ring 130 is, and exits on the other side of the piston 120 to reach chamber B (i.e. the second pathway).

When the compression force increases, ultimately beyond the threshold, the wedge-shaped gap closes and vanishes, sealing off the first pathway, leaving the second pathway as the only route of communication for the damping fluid from A to B. The damping action thus increases rapidly.

It can be understood that the outer shape of the O-ring 130 is larger than the span or cross-sectional area of the piston assembly 120; for example, the outer diameter of the O-ring is larger than the average diameter of the piston assembly (which may or may not be cylindrical), and preferably larger than the maximum diameter of the latter.

Preferably, the O-ring 130 is dimensioned such that even when tilted, its outer circumference is still snug with the wall 112 of the casing 110, so the fluid can only flow past the O-ring through its aperture, at all times. The diameter of the O-ring is thus at least as large as the diameter of the inner space of the casing.

Preferably, the protrusion 124 is dimensioned such that, when the O-ring 130 is unforced (despite a compression stroke) and simply touching the contact surface 122 of the piston assembly 120 without deformation in an inclined manner relative to the contact surface (which is generally parallel to the cross-section of housing 100 and perpendicular to the longitudinal axis X of the damper, neglecting the protrusion), the angle G formed between the plane of the inclined O-ring 130 and the contact surface 122 is equal to or more than 2 degrees. Preferably, this angle of tilt G is equal to or less than 8 degrees.

Different embodiments are possible to achieve the same technical aims.

For example, the contact surface 122 comprises one or more grooves 125 formed thereon, instead of the one or more protrusion(s) (see FIG. 4B) or in addition to the protrusion(s) (see FIG. 4C). These grooves become blocked when the compression forces the O-ring 130 and the contact surface 122 towards each other, through (partial) deformation of the O-ring. In an embodiment without protrusions, the O-ring may not be in a tilted position before deformation.

As another example, a protrusion is not formed on the contact surface 122 of the damper assembly 120, but the O-ring 130 comprises one or more protrusions 132 on the back side that faces the contact surface 122 (as shown in FIG. 5A), as the means to cause tilting and lead to deformation at pressure. Note that any ribs 132 on the O-ring are not merely intended as a distancing means for back flow during the return stroke. Alternatively or additionally, the O-ring 130 comprises one or more grooves 134 on that back-facing side (as shown FIG. 5B) that disappears when the compression forces the O-ring and the contact surface towards each other.

In general, corresponding protrusions or grooves may be formed on either or both of the O-ring 130 and the piston contact surface 122 to implement or assist their coming together to achieve tight sealing of the first passageway as appropriate.

As mentioned, the O-ring 130 is not completely freely floating on one side of the piston assembly 122 in chamber A, but kept in the vicinity of the contact surface by the stem 128 culminating in the end cap 129. The size (length and thickness) of the stem from the contact surface to the end cap may be chosen to limit the longitudinal range of movement and the extent of tilting of the O-ring. For example, the maximum angle of tilt may be anywhere between 2 to 8 degrees.

On the return stroke, the O-ring 130 moves out of engagement with the contact surface 122 of the piston assembly 120, thereby restoring the availability of both the first and second pathways for the damping fluid to flow from chamber B to chamber A.

In the above embodiments in which the tilt of the O-ring 130 changes, the threshold at which the compression force or speed becomes large enough to cause one of the passageways between the two chambers to close is related to the angle of inclination of the O-ring 130; the latter in turn depends on the size and shape of the O-ring 130 and the protrusion 124 on the piston assembly 120, for example. As the force increases during a compression stroke, the angle G decreases, and at a certain point the gap becomes small enough that the first pathway is blocked, leaving the second pathway alone to define the damping. This means that by implementing a smaller “default” tilt angle of the O-ring 130 in the second position, such as by using a smaller protrusion 124 on the contact surface 122, it is relatively easy to reach that point, i.e. the force or speed threshold is lower, as the O-ring needs to undergo less deformation to reach the second position flat against the contact surface.

This force threshold is also related to the stiffness (i.e. degree of flexibility) of the O-ring 130. Alternatively or additionally to the above, when designing a damper one could choose a harder, less pliant material for the ring, so that a stronger force or higher speed on the compression stroke is required to cause it 130 to flex, i.e. the threshold is higher; choosing a softer, more flexible material means the ring needs to flex less in order to change from being tilted to being in full contact with the contact surface 122, i.e. the threshold is lower.

It is important to note that the presently disclosed damper arrangement is intended to provide two different levels of damping on the compression stroke depending on the force/speed of the compression on the piston, and not just to ensure modified pathways between the compression stroke and the return stroke. The O-ring does not necessarily flex in all compression strokes. During a single compression stroke, it is not necessarily always in a flexed state, and it may not flex at all but remains in an unflexed state throughout.

The present invention is not to be limited by the above-described aspects and embodiments, and that many variations are within the scope of the appended claims. The various aspects and embodiments may be combined if necessary and appropriate. The drawings serve as exemplary illustrations of the invention only, to aid understanding of the invention.

1. A piston-and-cylinder-type damper operable to perform a compression stroke and a return stroke, comprising:
a casing containing damping fluid;
an O-ring inside the casing; and
a piston assembly having a contact surface facing the O-ring;
wherein, during a compression stroke:
when a compression speed or force of the piston assembly is relatively low, the O-ring is disposed at a first position relative to the piston assembly defining a first pathway and a second pathway for the damping fluid to flow from a first chamber to a second chamber, and
when the compression speed or force of the piston assembly is relatively high, the O-ring is disposed at a second position relative to the piston assembly blocking the first pathway and allowing the damping fluid to flow only through the second pathway,
wherein the first passageway is defined between an outer perimeter of the piston assembly and an inner wall of the casing.

2. The damper according to claim 1, wherein the O-ring is made of a flexible material, and is deformed when at the second position and undeformed when at the first position.

3. The damper according to claim 1, wherein when in the first position the O-ring is tilted at an angle with respect to the contact surface.

4. The damper according to claim 3, where the angle is between 2 degrees and 8 degrees.

5. The damper according to claim 1, wherein when the O-ring is in the second position a plane of the O-ring is parallel to the contact surface.

6. The damper according to claim 1, wherein the second pathway for the damping fluid to flow from the first chamber to the second chamber is an internal passage in the piston assembly.

7. The damper according to claim 6, wherein the second pathway has an opening on the contact surface at a position corresponding to the central hole of the O-ring.

8. The damper according to claim 1, wherein the contact surface of the piston assembly comprises a protrusion, and when the compression speed or force is relatively high, the O-ring is forced against the contact surface and deformed to wrap around the protrusion whilst in the second position.

9. The damper according to claim 8, wherein the contact surface of the piston assembly comprises exactly one protrusion.

10. The damper according to claim 1, wherein the O-ring comprises a protrusion facing the contact surface, and, when the compression speed or force is relatively high, the O-ring is forced against the contact surface whilst in the second position.

11. The damper according to claim 1, wherein the contact surface further comprises at least one groove, and/or the O-ring comprises at least one groove facing the contact surface.

12. The damper according to claim 1, wherein an outer circumference of the O-ring is at all times snug against the inner wall of the casing so that, during a compression stroke or a return stroke, the damping fluid can only flow past the O-ring through its central hole.

13. The damper according to claim 12, wherein the O-ring has a diameter that is equal to or larger than an inner diameter of the casing.

14. The damper according to claim 3, wherein a threshold of the compression speed or force above which the O-ring blocks the first pathway, is defined by the stiffness of the O-ring.

15. A piston-and-cylinder-type damper operable to perform a compression stroke and a return stroke, the damper comprising:
a cylinder containing damping fluid and having an inner wall;
a flexible O-ring; and
a piston assembly having a contact surface comprising a rib facing the O-ring;
wherein the O-ring is operable to move, dependent on a speed of a compression stroke, between: a first angle, at which the O-ring flexes around the rib and seals off a first damper fluid passage between a perimeter of the piston assembly and the inner wall of the cylinder, and a second angle, at which the O-ring leaves open the first damper fluid passage, said first and second angles defined as between a plane of the O-ring and a plane of the contact surface.

16. The damper according to claim 15, wherein the first angle is zero and the second angle is between 2 and 8 degrees.

17. The damper according to claim 15, further comprising a second damper fluid passage defined in the piston assembly, wherein the second damper fluid passage is open to the damping fluid when the O-ring is at the first angle and when the O-ring is at the second angle.
